(19) United States
(12) Patent Application Publication
(10) Pub. No.: US 2001/0038788 A1
(43) Pub. Date: Nov. 8, 2001

(54) Dock lifting device

(76) Inventors: Candi Jane Robinson, Venetia, PA (US); John Sabol, Pittsburgh, PA (US)

Correspondence Address: Alan G. Towner, Eckert Seamans Cherin & Mellott, LLC, 600 Grant Street, 44th Floor, Pittsburgh, PA, 15219, US

(21) Appl. No.: 09/732,317

(22) Filed: Dec. 7, 2000

Related U.S. Application Data
(60) Provisional application No. 60/170,124, filed on Dec. 10, 1999.

(51) Int. Cl. B66F 7/00

(52) U.S. Cl. 414/607

(57) ABSTRACT

The present invention provides a dock lifting device which facilitates movement of cargo from areas of different height. For example, the lifting device may be used in combination with a forklift to move items from a relatively high loading dock to a relatively low loading platform such as a pickup truck, station wagon or the ground. The lifting device preferably includes a first end adapted to receive the forks of a forklift, and a second end including a cargo platform that is positioned below the height of the first end.

### CROSS REFERENCE TO RELATED APPLICATION

This application claims the benefit of U.S. Provisional Patent Application Serial No. 60/170,124 filed Dec. 10, 1999.

### FIELD OF THE INVENTION

The present invention relates to dock lifting devices, and more particularly relates to a device for lifting various items between a relatively high loading dock and a relatively low loading platform such as a pick-up truck, station wagon or the ground.

### BACKGROUND INFORMATION

Loading docks are typically provided at the same level as a standard tractor trailer in order to facilitate loading. However, it is often necessary to load and unload various items from lower heights, e.g., from pick-up trucks, station wagons and the ground. The present invention provides a device which facilitates such loading operations.

### SUMMARY OF THE INVENTION

The present invention provides a lifting device for transferring various items. In a preferred embodiment, the items are transferred between a relatively high loading dock and a relatively low loading platform such as a pickup truck, station wagon or the ground.

An aspect of the present invention is to provide a lifting device. The lifting device comprises a first end structured and configured to receive at least one fork of a forklift, and a second end including a cargo platform connected to the first end and positioned at a different height from the first end.

Another aspect of the present invention is to provide a forklift adaptor. The forklift adaptor comprises a first end including support members adapted to receive forks of the forklift, and a second end including a cargo platform connected to the first end and positioned at a height below the first end.

A further aspect of the present invention is to provide a lifting device which includes means for engagement with forks of a forklift, and means positioned at a height below the fork engagement means for lifting items between a relatively high loading dock and a relatively low loading platform.

These and other aspects of the present invention will be more apparent from the following description.

### BRIEF DESCRIPTION OF THE DRAWINGS

FIG. 1 is an isometric view of a forklift on a loading dock supporting a lifting device in accordance with an embodiment of the present invention.

FIG. 2 is an isometric view of a lifting device in accordance with an embodiment of the present invention.

FIG. 3 is a side view of the lifting device of FIG. 2.

FIG. 4 is an isometric view of a lifting device in accordance with another embodiment of the present invention.

FIG. 5 is a side view of the lifting device of FIG. 4.

FIG. 6 is an isometric view of a lifting device in accordance with a further embodiment of the present invention.

FIG. 7 is a side view of the lifting device of FIG. 6.

### DETAILED DESCRIPTION

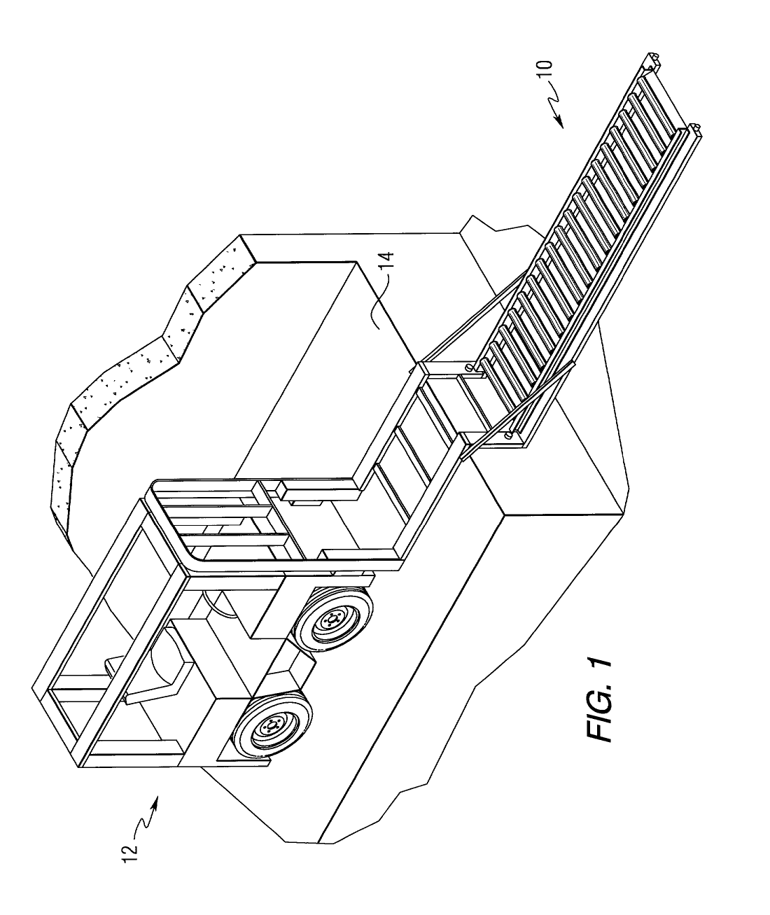

FIG. 1 illustrates a dock lifting device 10 in accordance with an embodiment of the present invention. One end of the lifting device 10 is mounted on the forks of a conventional forklift 12. The forklift 12 travels on the floor of a relatively high loading dock 14.

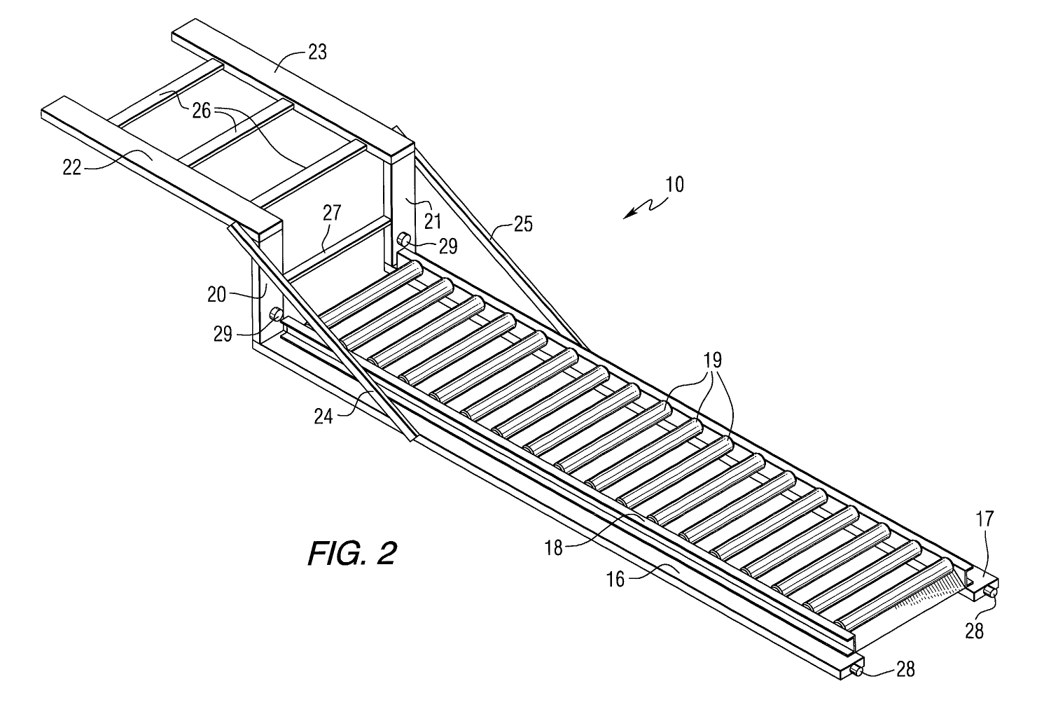

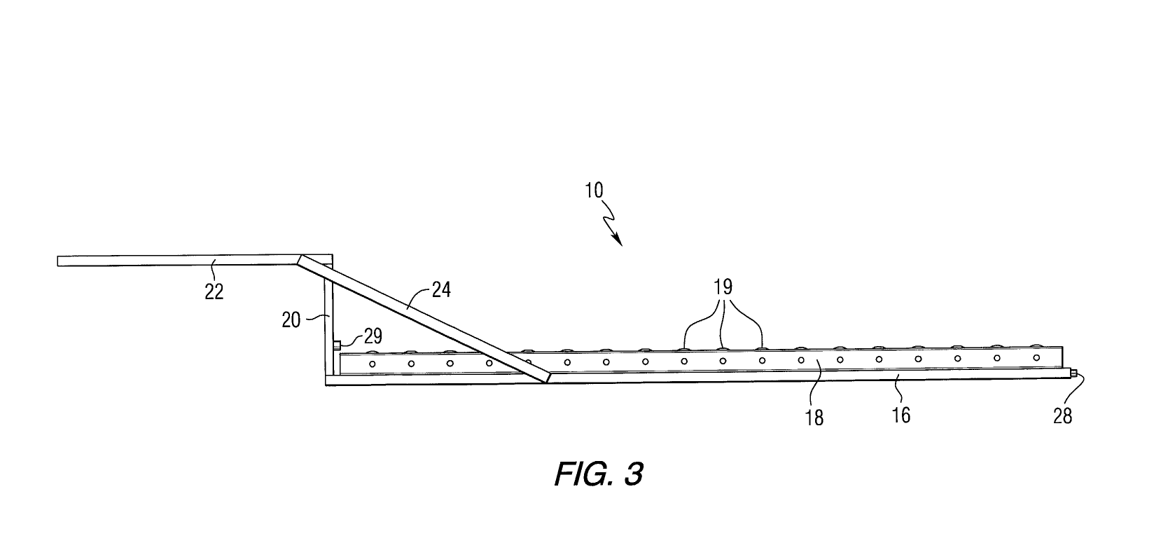

As shown in FIGS. 2 and 3, the one end of the lifting device 10 includes two horizontal support members 16 and 17. A roller rack 18 having multiple rollers 19 is supported on the horizontal members 16 and 17. The roller rack 18 provides a cargo platform of the lifting device. Vertical support members 20 and 21 are attached to the horizontal members 16 and 17, respectively. A second set of horizontal members 22 and 23 at the other end of the lifting device 10 are connected to the vertical support members 20 and 21. The horizontal members 22 and 23 are adapted to accept the forks of a standard forklift. A reinforcing member 24 is connected between the horizontal support members 16 and 22. Another reinforcing member 25 is connected between the horizontal support members 17 and 23. Reinforcing bars 26 are connected between the horizontal support members 22 and 23. Another reinforcing bar 27 is connected between the vertical support members 20 and 21. Resilient bumpers 28 are attached to the ends of the horizontal support members 16 and 17. Another set of resilient bumpers 29 are attached to the vertical support members 20 and 21 at one end of the roller rack 18.

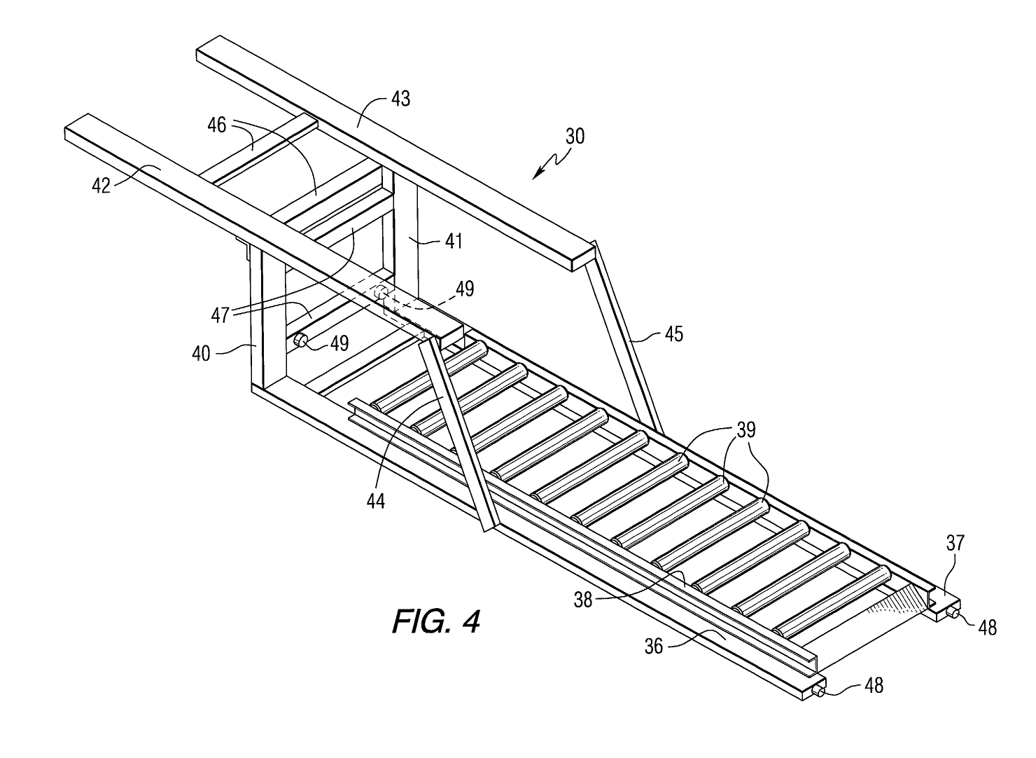

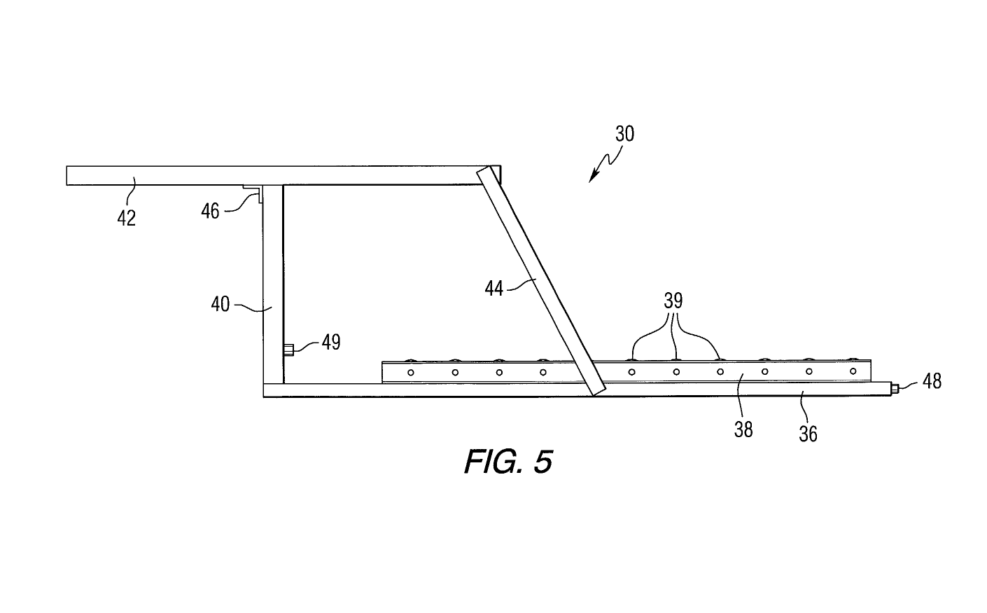

FIGS. 4 and 5 illustrate another dock lifting device 30 in accordance with a further embodiment of the invention. One end of the lifting device 30 includes horizontal support members 36 and 37 which support a roller rack 38 having multiple rollers 39. The roller rack 38 provides a cargo platform. Vertical support members 40 and 41 are connected to the horizontal support members 36 and 37. Each vertical support member 40 and 41 is connected to a horizontal support member 42 and 43, respectively. The horizontal support members 42 and 43 are adapted to receive the forks of a standard forklift. By connecting the vertical support members 40 and 41 near the middle of the horizontal support members 42 and 43 as shown in FIGS. 4 and 5, the overall length of the dock lifting device 30 may be decreased in comparison with the embodiment shown in FIGS. 2 and 3. In this embodiment, a portion of the roller rack 38 is positioned underneath a portion of the support members 42 and 43. Reinforcing bars 46 and 47 provide increased structural rigidity. Resilient bumpers 48 are mounted at the ends of the horizontal support members 36 and 37. Similarly, resilient bumpers 49 are mounted on one of the reinforcing bars 47 near the end of the roller rack 38.

In accordance with the present invention, the height difference between the upper and lower horizontal support members is selected in order to facilitate movement of cargo from loading areas of different heights. For example, the vertical distance between the lower horizontal support members 16, 17 and the upper horizontal support members 22, 23 in the embodiment of FIGS. 2 and 3 typically ranges from about 0.5 to about 6 feet. Preferably, the vertical distance or height difference ranges from about 1 to about 5 feet, more preferably from about 2 to about 4 feet. In a particularly preferred embodiment, the height difference is approximately 3 feet.

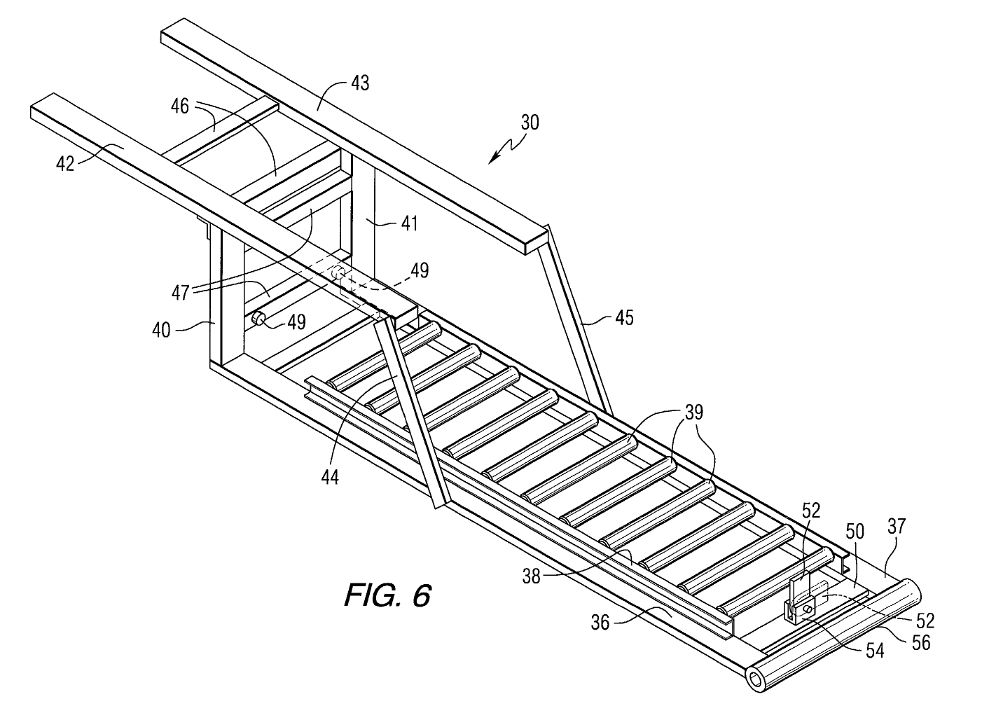

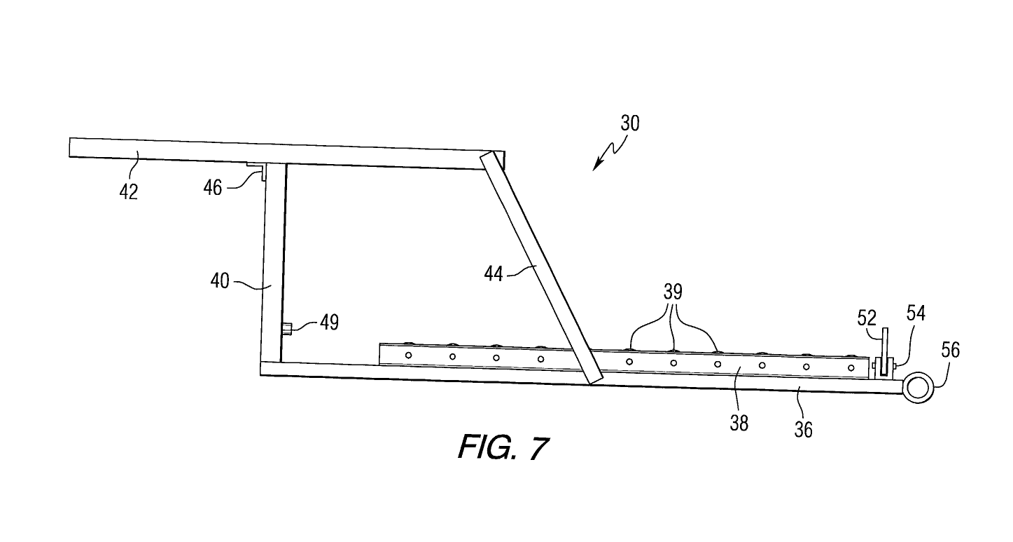

FIGS. 6 and 7 illustrate a dock lifting device 30 similar to the embodiment shown in FIGS. 4 and 5, with the addition of a stop mechanism which prevents cargo from rolling off the lifting device 30 during transport operations. A horizontal cross bar 50 extends between the support members 36 and 37. The stop mechanism is fastened on the cross bar 50 and includes an arm 52 rotatably mounted in a bracket 54. The arm 52 is rotatable from an extended position to a retracted position, shown in phantom in FIG. 6. The retractable stopper mechanism 52, 54 shown in FIGS. 6 and 7 permits cargo to be loaded on the rollers 39 of the lifting device 30 when the arm 52 is in the retracted position. After the cargo has been loaded on the rollers 39, the arm 52 may be rotated to the extended position shown in FIGS. 6 and 7 to prevent the loaded cargo from rolling off the lifting device 30 during transport. The embodiment of the lifting device 30 shown in FIGS. 6 and 7 includes a tubular bumper 56 made of any suitable resilient material such as rubber mounted at the ends of the horizontal support members 36 and 37.

Although the stopper mechanism 52, 54 shown in FIGS. 6 and 7 includes a rotatable arm, any suitable mechanism may be used. For example, the stopper mechanism may automatically pivot, fold or otherwise move to a retracted position when contacted by cargo as it is being loaded onto the rollers 39 of the lifting device 30. After the cargo has been loaded, such an automatic stopper mechanism (not shown) may move to an extended or locking position through the use of a spring or other suitable biasing means. Although one stopper mechanism 52, 54 is illustrated in the embodiment shown in FIGS. 6 and 7, multiple stopper mechanisms may be used, for example, at various locations along the roller rack 38 of the lifting device 30. The stopper mechanism(s) may be positioned at any desired location on the lifting device 30. The stopper mechanism may include one or more brakes (not shown) which selectively prevent rotation of one or more of the rollers 39 after cargo has been loaded on the lifting device 30. With the brake(s) engaged, the loaded cargo cannot freely roll along the length of the roller rack 38, but instead is held by frictional forces of the non-rotating roller(s).

The components of the dock lifting devices 10 and 30 shown in FIGS. 2-7 may be made of any suitable materials, such as steel, aluminum, etc. The components of the dock lifting device 10 may be attached together by any suitable means such as welding, brazing, or mechanical fasteners such as bolts, screws, rivets, etc.

The dock lifting devices of the present invention may be used for loading various cargo items. For example, in the embodiments shown in FIGS. 2-7, the dock lifting devices are adapted for loading relatively long and narrow items, such as containers for human remains typically used in the air transport industry. For this application, the height of the horizontal support members and roller rack are adjusted for loading to or from a hearse. However, the height of the horizontal support members and roller rack of the dock lifting device may be adjusted depending on the particular loading operation to be performed. Furthermore, the lifting device may be adapted for loading various other items of different shapes and sizes. For example, the dimensions of the lifting device could be modified for relatively short and wide items. Thus, the height, length and width of the lifting device may be modified as necessary depending upon the particular loading operation and in order to provide the desired loading surface area.

Although the lifting devices shown in FIGS. 1-7 include a series of rollers which facilitate loading and unloading of cargo in a direction along the length of the lifting device, the orientation of the rollers may be changed, or rollers having multiple orientations may be used, depending upon the particular loading operation. Furthermore, if loading in more than one direction is desired, the rollers may be replaced with other mechanisms such as roller balls which allow cargo movement in any horizontal direction.

Whereas particular embodiments of this invention have been described above for purposes of illustration, it will be evident to those skilled in the art that numerous variations of the details of the present invention may be made without departing from the invention as defined in the appended claims.

1. A lifting device comprising:
a first end structured and configured to receive at least one fork of a forklift; and
a second end including a cargo platform connected to the first end and positioned at a different height from the first end.

2. The lifting device of claim 1, wherein the first end includes two support members which each receive a fork of the forklift.

3. The lifting device of claim 1, wherein the second end is positioned below the first end.

4. The lifting device of claim 3, wherein the difference in height between the first and second ends is from about 0.5 to about 6 feet.

5. The lifting device of claim 3, wherein the difference in height between the first and second ends is from about 1 to about 5 feet.

6. The lifting device of claim 3, wherein the difference in height between the first and second ends is from about 2 to about 4 feet.

7. The lifting device of claim 3, wherein at least a portion of the cargo platform is positioned underneath at least a portion of the support members.

8. The lifting device of claim 1, wherein the support members are substantially horizontal.

9. The lifting device of claim 1, wherein the cargo platform comprises a series of rollers.

10. The lifting device of claim 9, wherein the cargo platform comprises a stop mechanism for selectively presenting cargo from rolling off the cargo platform after the cargo has been loaded on the rollers.

11. The lifting device of claim 1, wherein the cargo platform comprises a stop mechanism for selectively preventing cargo from sliding off the cargo platform after the cargo has been loaded on the cargo platform.

12. The lifting device of claim 11, wherein the stop mechanism is movable from a retracted position to an extended position.

13. A forklift adaptor comprising:
a first end including support members adapted to receive forks of the forklift; and
a second end including a cargo platform connected to the first end and positioned at a height below the first end.

14. The forklift adaptor of claim 13, wherein the difference in height between the first and second ends is from about 0.5 to about 6 feet.

15. The forklift adaptor of claim 13, wherein the difference in height between the first and second ends is from about 1 to about 5 feet.

16. The forklift adaptor of claim 13, wherein the difference in height between the first and second ends is from about 2 to about 4 feet.

17. The forklift adaptor of claim 13, wherein at least a portion of the cargo platform is positioned underneath at least a portion of the support members.

18. The forklift adaptor of claim 13, wherein the support members are substantially horizontal.

19. The forklift adaptor of claim 13, wherein the cargo platform comprises a series of rollers.

20. The forklift adaptor of claim 13, wherein the cargo platform comprises a stop mechanism for selectively presenting cargo from rolling off the cargo platform after the cargo has been loaded on the rollers.

21. The forklift adaptor of claim 13, wherein the cargo platform comprises a stop mechanism for selectively preventing cargo from sliding off the cargo platform after the cargo has been loaded on the cargo platform.

22. The forklift adaptor of claim 13, wherein the stop mechanism is movable from a retracted position to an extended position.

23. A lifting device comprising:
means for engagement with forks of a forklift; and
means positioned at a height below the fork engagement means for lifting items between a relatively high loading dock and a relatively low loading platform.

24. The lifting device of claim 23, wherein the height is from about 0.5 to about 6 feet.

25. The lifting device of claim 23, wherein the height is from about 1 to about 5 feet.

26. The lifting device of claim 23, wherein the height is from about 2 to about 4 feet.

27. The lifting device of claim 23, further comprising means for preventing the items from falling from the lifting device when the items are being lifted.

28. The lifting device of claim 27, wherein the means for preventing the items from falling comprises a stop mechanism which selectively prevents the items from sliding or rolling off the lifting device.
